(19) United States
(12) Patent Application Publication
(10) Pub. No.: US 2026/0063212 A1
(43) Pub. Date: Mar. 5, 2026

(54) VALVE FOR A FLUID SYSTEM OF A VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/384,251

(22) Filed: Nov. 10, 2025

Related U.S. Application Data
(63) Continuation of application No. PCT/EP2024/062235, filed on May 3, 2024.

(30) Foreign Application Priority Data
May 10, 2023 (DE) 10 2023 112 247.9

(51) Int. Cl. F16K 11/085; F16K 5/04

(52) U.S. Cl. CPC F16K 11/0856; F16K 5/0471

(57) ABSTRACT

A valve for a fluid system of a vehicle, comprising a valve housing having a plurality of valve housing openings. A valve body has a first level with at least one first connecting passage, and has a second level with at least one second connecting passage for connecting at least two valve housing openings in a flow-conducting manner. A valve seal and a valve drive automatically rotate the valve body. The valve seal is formed with a continuous slot that is connected in a flow-conducting manner with at least one of the valve housing openings in at least one switching state of the valve. The valve body and the valve seal are designed to be coordinated with one another such that, in each switching state of the valve, it is ensured that the valve housing openings are only connected to each other in the desired flow-conducting manner.

This nonprovisional application is a continuation of International Application No. PCT/EP2024/062235, which was filed on May 3, 2024, and which claims priority to German Patent Application No. 10 2023 112 247.9, which was filed in Germany on May 10, 2023, and which are both herein incorporated by reference.

### BACKGROUND OF THE INVENTION

### Field of the Invention

The present invention relates to a valve for a fluid system of a vehicle.

### Description of the Background Art

Valves for fluid systems of vehicles are known fan typically have: a valve housing having a base, a top, and having a multiplicity of valve housing openings arranged in a side wall of the valve housing; a valve body arranged in the valve housing so as to be rotatable about a rotational axis and having, arranged perpendicular to the rotational axis, a first level that has at least one first connecting passage, and having, arranged perpendicular to the rotational axis, a second level that is fluidically separated from the first level by an intermediate base and has at least one second connecting passage, in each case for the purpose of fluidically connecting at least two valve housing openings of the multiplicity of valve housing openings; a valve seal that is arranged between the valve housing and the valve body and has valve seal openings corresponding to the valve housing openings; and a valve actuating device for automatically rotating the valve body about the rotational axis for the purpose of setting a multiplicity of switching states of the valve.

This is the starting point for the present invention.

### SUMMARY OF THE INVENTION

It is therefore an object of the present invention is to improve a valve for a fluid system of a vehicle.

This object is attained in an example by a valve for a fluid system of a vehicle, which is characterized in that the valve seal is designed as a slotted seal with a continuous slot that extends along the rotational axis, wherein the slot is in fluidic connection with at least one of the valve housing openings in at least one switching state of the valve, and wherein the valve body and the valve seal are designed to be matched to one another such that it is ensured in every switching state of the valve that the valve housing openings are fluidically connected to one another only in the desired manner. The dependent claims relate to advantageous improvements of the invention.

An important advantage of the valve according to the invention for a fluid system of a vehicle is, in particular, that a valve for a fluid system of a vehicle is improved. On account of the design according to the invention of the valve for a fluid system of a vehicle, the valve is substantially simplified in terms of design, manufacturing, and switching. At the same time, the functionality of the valve according to the invention for a fluid system of a vehicle is comparable to the functionality of far more complex valves or the use of a multiplicity of simpler valves. By means of the valve according to the invention for a fluid system of a vehicle, it is possible, in particular, to specify a valve that is more complex and has more possible switching states as compared to the prior art, despite a valve seal designed as a slotted seal and with comparable available installation space. This is because, in the valve according to the invention, unlike in the valves known from the prior art, the slot of the valve seal is in fluidic connection with at least one of the valve housing openings in at least one switching state of the valve. In an example of the invention, provision can be made in this case that the slot of the valve seal in at least one switching state of the valve is in fluidic connection with at least two of the valve housing openings, wherein these valve housing openings are fluidically connected to one another in a desired manner in this switching state. In contrast thereto, the slot in comparable valve seals from the prior art is always arranged such that the slot is not in fluidic connection with at least one of the valve housing openings in any conceivable switching state of the known valve. The available installation space in the valves known from the prior art thus is not as extensively usable for switching states of these valves as is the case with the invention. Accordingly, these known valves have a smaller number of possible switching states in comparison with the valve according to the invention.

The valve according to the invention for a fluid system of a vehicle can be freely chosen within broad suitable limits in terms of type, mode of operation, material, and dimensioning. The potential applications of the valve according to the invention are correspondingly diverse. Strictly by way of example, reference is made here only to thermal management systems of electric vehicles, in particular to their coolant systems.

An advantageous improvement of the valve according to the invention provides that the valve seal can be designed as a slotted tube, and/or that the valve body and the intermediate base are designed to be matched to one another such that one of the at least one first connecting passages and one of the at least one second connecting passages form a fluidic connection between the first level and the second level as a common connecting passage. in this way, a valve seal according to the invention is specified with a geometry that is especially advantageous in terms of design and manufacturing on the one hand, and on the other hand a fluidic connection between the first level and the second level of the valve according to the invention is specified in a manner that is very simple in terms of design and manufacturing. The latter is true independently of the slot of the valve seal, in particular.

A further advantageous improvement of the valve according to the invention provides that the valve body and the valve seal can be designed to be matched to one another such that one of the first valve housing openings and one of the second valve housing openings are fluidically connected to one another in a desired manner by means of the slot in at least one of the switching states of the valve, preferably that the fluidic connection is formed by means of one of the at least one first connecting passages and one of the at least one second connecting passages, especially preferably that the fluidic connection is formed solely by means of just one of the at least one first connecting passages and just one of the at least one second connecting passages. By this means, alternatively or in addition to the aforementioned improvement, a fluidic connection between the first level and the second level of the valve according to the invention is specified in a manner that likewise is very simple in terms of design and manufacturing. The example of this improvement has the additional advantage that the fundamental separation in terms of flow of the first level from the second level remains usable for corresponding switching states of the valve according to the invention despite the fluidic connection existing between the two levels in the aforementioned manner.

The valve body and the valve seal can be designed to be matched to one another such that the valve body isolates the slot in terms of flow in a desired manner from every first valve housing opening and/or from every second valve housing opening in at least one of the switching states of the valve. In this way, at least one switching state of the valve according to the invention is made possible in which a fluidic separation of the first level from the second level is mandatory, despite the slot in the valve seal being in fluidic connection with at least one of the valve housing openings.

One of the at least one first and/or at least one second connecting passages can be designed such that at least three valve housing openings associated with the same level as this connecting passage can be fluidically connected to one another by means of this connecting passage as a function of one of the switching states of the valve. As a result, an example of the invention is specified that is relatively simple in terms of design and manufacturing but that nevertheless makes it possible to implement a large number of switching states of the valve according to the invention.

Three valve housing openings in total can be associated with the level, preferably that these three valve housing openings are associated only with the level. A good compromise is provided in this way between an example of the invention that is relatively simple in terms of design and manufacturing, on the one hand, and a large number of possible switching states of the valve according to the invention on the other hand.

The connecting passage can be delimited by at least one valve body wall, preferably that the at least one valve body wall is designed as three valve housing walls in total. The connecting passage can be implemented in a manner that is especially simple in terms of design and manufacturing by this means.

The connecting passage can be fluidically separated from at least one other connecting passage of the level by means of at least one of the at least one valve body walls, preferably that the valve body and the intermediate base are designed to be matched to one another such that the connecting passage and/or the other connecting passage form/forms a fluidic connection between the first level and the second level. In this way, the construction effort in manufacturing the valve according to the invention is significantly reduced while at the same time functionality of the valve according to the invention is improved. The example of this improvement additionally has the further advantage that a fluidic connection is also produced between the two levels by means of the connecting passage and/or the other connecting passage.

A further advantageous improvement of the valve according to the invention provides that, on the one hand, at least four valve housing openings and at least three first connecting passages can be associated with the first level, and on the other hand, at least three valve housing openings and at least two connecting passages can be associated with the second level, preferably that at least three of the first connecting passages are fluidically separated from one another only by a single valve body wall, and/or that at least two of the second connecting passages are separated only by a single valve body wall, especially preferably that the valve body and the intermediate base are designed to be matched to one another such that one of the first connecting passages and one of the second connecting passages are designed as a single, common connecting passage. An example of the valve according to the invention that is very advantageous in practice is specified by this means.

Furthermore, another advantageous improvement of the valve according to the invention provides that at least four switching states can be implemented by means of the valve, preferably that the following valve housing openings are fluidically connected to one another in a first switching state: a valve housing opening A associated with the first level to a valve housing opening B associated with the first level, a valve housing opening C associated with the first level to a valve housing opening D associated with the first level, a valve housing opening E associated with the second level to the valve housing openings F and G likewise associated with the second level, and/or that the following valve housing openings are fluidically connected to one another in a second switching state: a valve housing opening B associated with the first level to a valve housing opening D likewise associated with the first level, a valve housing opening E associated with the second level to a valve housing opening G likewise associated with the second level, and/or that the following valve housing openings are fluidically connected to one another in a third switching state: a valve housing opening B associated with the first level to a valve housing opening D likewise associated with the first level, a valve housing opening C associated with the first level to a valve housing opening G associated with the second level, a valve housing opening E associated with the second level to a valve housing opening F likewise associated with the second level, and/or that the following valve housing openings are fluidically connected to one another in a fourth switching state: a valve housing opening A associated with the first level to a valve housing opening E associated with the second level, a valve housing opening C associated with the first level to a valve housing opening D likewise associated with the first level, a valve housing opening F associated with the second level to a valve housing opening G likewise associated with the second level. A multiplicity of fluidic connections solely by means of the valve according to the invention is made possible in this way. Furthermore, a sufficiently large spacing between the adjacent valve housing openings is present on the one hand, and on the other hand the transition between the individual switching states can take place rapidly enough.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows an example of the valve according to the invention in a fluid system of a vehicle, in a first switching state of the valve, in a schematic diagram of the process,

FIG. 1b shows the example from FIG. 1a with the two levels of the valve in individual views, in a cross section through the respective level in each case,

FIG. 2a shows the example in a second switching state of the valve, in an analogous representation to FIG. 1a,

FIG. 2b shows the example in the second switching state of the valve, in an analogous representation to FIG. 1b,

FIG. 3a shows the example in a third switching state of the valve, in an analogous representation to FIG. 1a,

FIG. 3b shows the example in the third switching state of the valve, in an analogous representation to FIG. 1b,

FIG. 4a shows the example in a fourth switching state of the valve, in an analogous representation to FIG. 1a, and

FIG. 4b shows the example in the fourth switching state of the valve, in an analogous representation to FIG. 1b.

### DETAILED DESCRIPTION

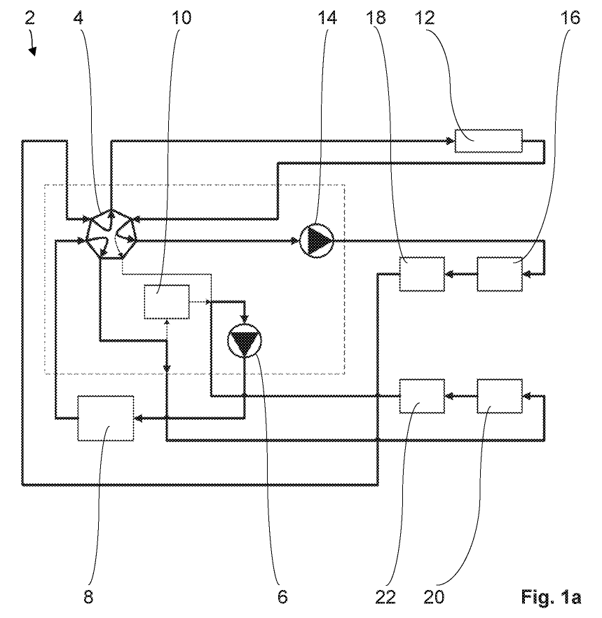

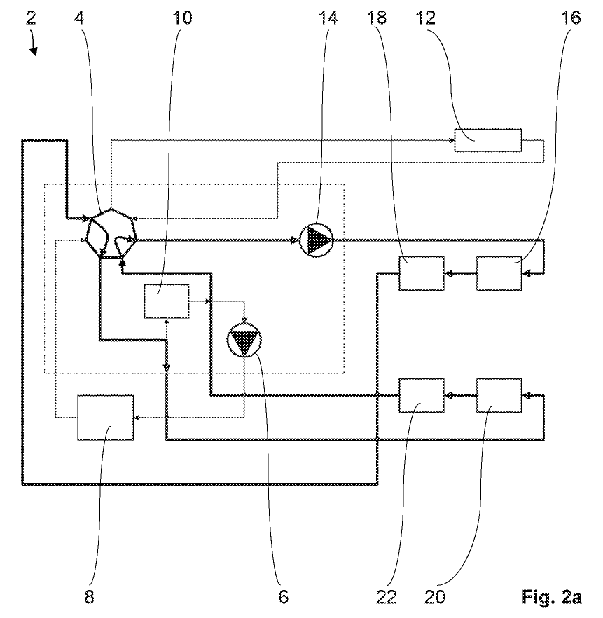

Shown strictly by way of example in FIG. 1a to 4b is an example of the valve according to the invention for a fluid system of a vehicle.

The vehicle is designed as an electric vehicle. The fluid system 2 is designed as a coolant system for the electric vehicle and has the valve 4 as the sole valve. In addition to the valve 4, the fluid system 2 in the present example comprises: a first coolant pump 6; a traction battery 8; a coolant tank 10; a front radiator 12; a second coolant pump 14; power electronics 16 and an electric motor 18 that works together with the power electronics 16 in a manner known per se to the person skilled in the art, namely working together as a so-called drive train, for driving the vehicle; an auxiliary electric heater 20; and a chiller 22. The components represent a coolant system of a vehicle purely by way of example here. Alternatively or additionally, the coolant system can also contain other components in other examples. The person skilled in the art will make the appropriate choice of components according to the requirements of the individual case. Of course, the valve according to the invention fundamentally can also be used advantageously for other fluid systems of a vehicle.

The valve 4 for the fluid system 2 comprises: a valve housing having a base 24, a top, and a multiplicity of valve housing openings A, B, C, D, E, F, G arranged in a side wall 26 of the valve housing; a valve body 28 arranged in the valve housing so as to be rotatable about a rotational axis extending perpendicular to the respective image plane of FIG. 1a to 4b and having, arranged perpendicular to the rotational axis, a first level 30 that has at least one first connecting passage 32, 34, 36 and having, arranged perpendicular to the rotational axis, a second level 38 that has at least one second connecting passage 34, 40, in each case for the purpose of fluidically connecting at least two valve housing openings A to G of the multiplicity of valve housing openings A to G; a valve seal 41 that is arranged between the valve housing and the valve body 28 and that has valve seal openings corresponding to the valve housing openings A to G; and a valve actuating device for automatically rotating the valve body 28 about the rotational axis. The first level 30 and the second level 38 are separated from one another in terms of flow by means of an intermediate base 42. The valve body 28 and the intermediate base 42 here are designed to be matched to one another such that one of the first connecting passages and one of the second connecting passages are designed as a single, common connecting passage 34. See FIG. 1b, 2b, 3b, and 4b in this regard. In each of these figures, a cross section through the first level 30 is depicted in the image plane on the left and a cross section through the second level 38 on the right. In the present example, the second level 38 is arranged above the first level 30. This is not mandatory, however, so in other examples of the invention the first level can also be arranged above the second level. In addition, the valve housing openings A to G in the respective image plane in FIG. 1a to 4b can also be mirror-imaged in their arrangement. Analogously, the connecting passages 32, 34, 36, and 40 would then also be mirror-imaged.

According to the invention, the valve seal 41 is designed as a slotted seal with a continuous slot 43 that extends along the rotational axis, wherein the slot 43 is in fluidic connection with at least one of the valve housing openings A to G in at least one switching state of the valve 4, and wherein the valve body 28 and the valve seal 41 are designed to be matched to one another such that it is ensured in every switching state of the valve 4 that the valve housing openings A to G are fluidically connected to one another only in the desired manner.

Three valve housing openings E, F, G in total are associated with the second level 38, wherein these three valve housing openings E, F, G in the present example are associated only with the level 38. Furthermore, the connecting passage 40 is delimited by at least one valve body wall, wherein the at least one valve body wall is designed here as three valve housing walls 44, 46, 48 in total. In addition, the connecting passage 40 is separated in terms of flow from at least one other connecting passage, namely the connecting passage 34, of the level, namely the second level 38, by means of at least one of the at least one valve body walls, namely only the valve body wall 44, wherein the valve body 28 and the intermediate base 42 are designed to be matched to one another such that this connecting passage 34 forms a fluidic connection between the first level 30 and the second level 38.

Four valve housing openings A, B, C, D in total and at least one first connecting passage, namely three first connecting passages 32, 34, 36, are associated with the first level 30, wherein the three first connecting passages 32, 34, 36 here are separated from one another in terms of flow only by a single valve body wall 50.

The mode of operation of the valve according to the invention in accordance with the present example is explained in detail below on the basis of FIG. 1a to 4b.

A multiplicity of switching states, namely four switching states in total, can be implemented by means of the valve 4.

In a first switching state, the following valve housing openings are fluidically connected to one another: the valve housing opening A associated with the first level 30 to the valve housing opening B associated with the first level 30, the valve housing opening C associated with the first level 30 to the valve housing opening D associated with the first level 30, the valve housing opening E associated with the second level 38 to the valve housing openings F and G likewise associated with the second level 38. In this way, the connecting passage 32 in the first level 30 and the connecting passage 40 in the second level 38 are connected to one another here by means of the slot 43 and separated from the other connecting passages 34, 36. This separation from the other connecting passages 34, 36 is accomplished in the first level 30 by means of the valve body wall 50 that delimits the connecting passage 32. In the second level 38, the separation from the other connecting passages, namely the common connecting passage 34, is accomplished by means of the valve body wall 44 that delimits the connecting passage 34. The slot 43 is indeed fluidically connected to the valve housing openings E, F, G in the second level 38; nevertheless, the flow from the valve housing opening F to the valve housing openings E and G is not substantially influenced by the slot 43. See FIG. 1a and 1b in this regard.

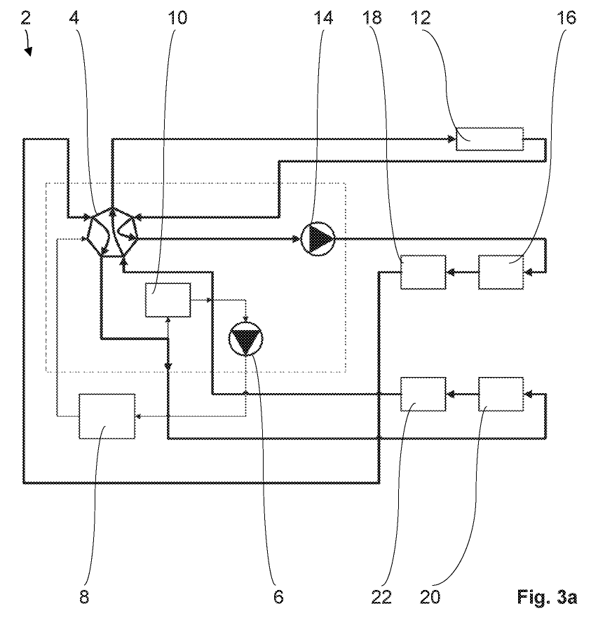

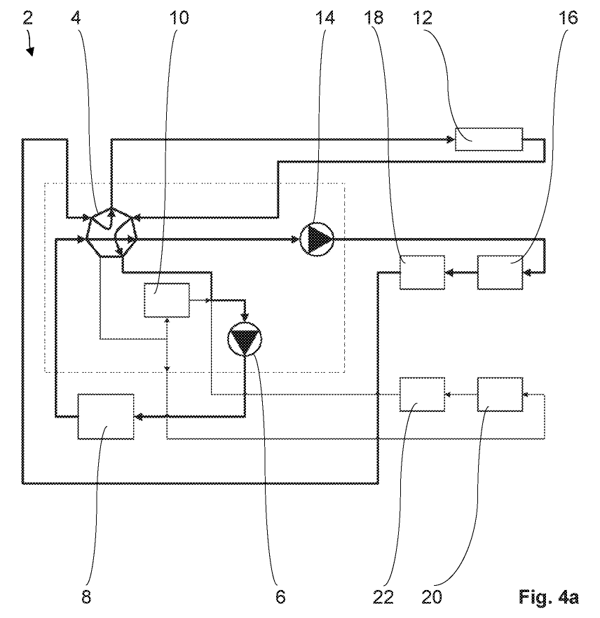

In a second switching state of the valve 4, the following valve housing openings are fluidically connected to one another: the valve housing opening B associated with the first level 30 to the valve housing opening D likewise associated with the first level 30, the valve housing opening E associated with the second level 38 to the valve housing opening G likewise associated with the second level 38. In the first level 30 and in the second level 38, the common connecting passage 34 is also fluidically connected to the slot 43 and separated from the other connecting passages 32, 36, and 40. This separation from the other connecting passages 32, 36, and 40 is accomplished in the first level 30 by means of the valve body wall 50 that delimits the connecting passage 34. In the second level 38, the separation is accomplished by means of the valve body wall 44 that delimits the connecting passage 34. The slot 43 is indeed fluidically connected to the valve housing opening C in the first level 30; nevertheless, the valve housing opening C is not in fluidic connection with one of the other valve housing openings A, B and D to G, so that the slot 43 cannot influence any of the desired flows. See FIG. 2a and 2b in this regard.

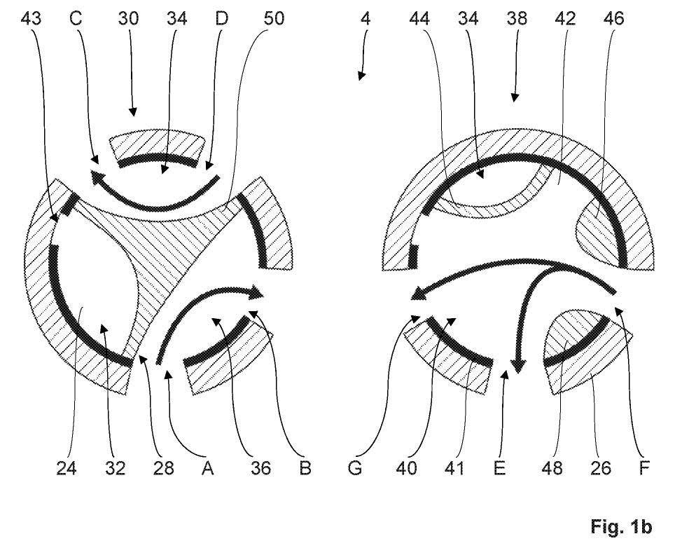

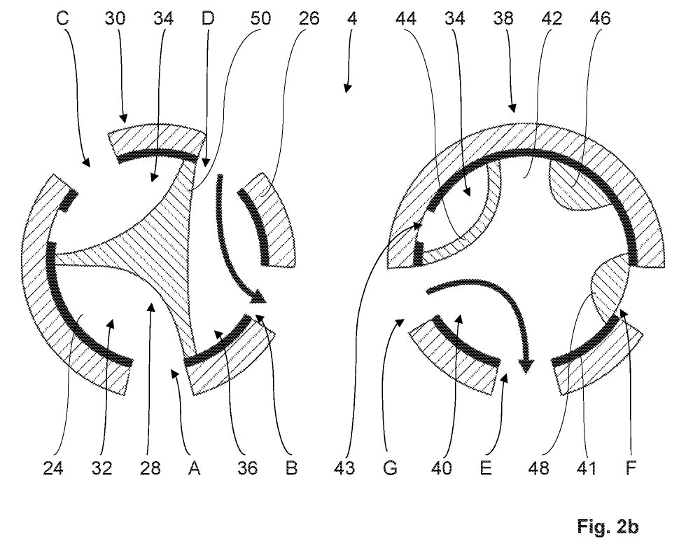

In a third switching state, the following valve housing openings are fluidically connected to one another in the present example: the valve housing opening B associated with the first level 30 to the valve housing opening D likewise associated with the first level 30, the valve housing opening C associated with the first level 30 to the valve housing opening G associated with the second level 38, the valve housing opening E associated with the second level 38 to the valve housing opening F likewise associated with the second level 38. Here, the common connecting passage 34 in the first level 30 and in the second level 38 are also connected to one another by means of the slot 43 and separated from the other connecting passages 32, 36, and 40. This separation from the other connecting passages 32, 36, and 40 is accomplished in the first level 30 by means of the valve body wall 50 that delimits the connecting passage 34. In the second level 38, the separation is accomplished by means of the valve body wall 44 which delimits the connecting passage 34. The slot 43 is fluidically connected to the valve housing opening C in the first level 30 and to the valve housing opening G in the second level 38, so that, on the one hand, the valve housing openings G and C are fluidically connected to one another in a desired manner by means of the slot 43. On the other hand, the other desired flows are not influenced by the slot 43. See FIG. 3a and 3b in this regard.

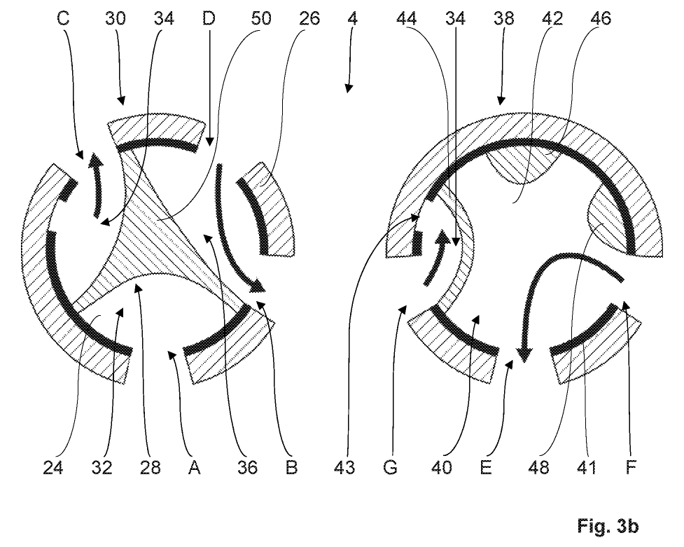

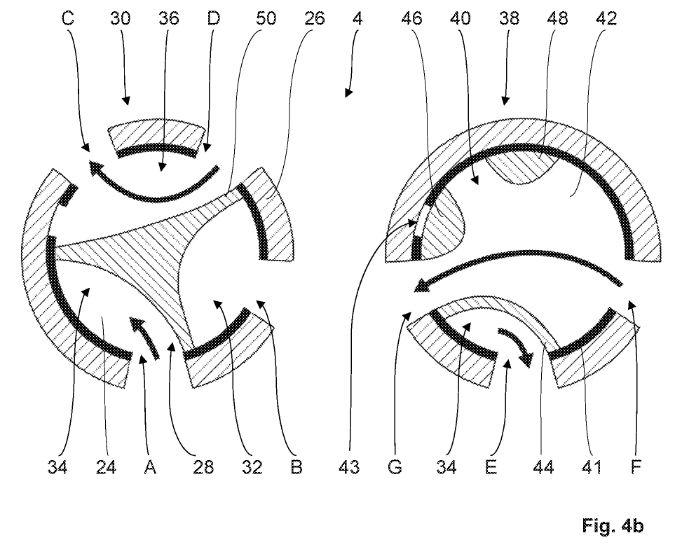

Furthermore, the following valve housing openings are fluidically connected to one another in a fourth switching state: the valve housing opening A associated with the first level 30 to the valve housing opening E associated with the second level 38, the valve housing opening C associated with the first level 30 to the valve housing opening D likewise associated with the first level 30, the valve housing opening F associated with the second level 38 to the valve housing opening G likewise associated with the second level 38. The connecting passage 36 in the first level 30 is connected to the slot 43 here. In the second level 38, in contrast, the slot 43 is closed in a fluid-tight manner by means of the valve body wall 46, so that the slot 43 has no fluidic connection to the second level 38. The slot 43 is indeed fluidically connected to the valve housing openings C and D in the first level 30; nevertheless, the flow from the valve housing opening D to the valve housing opening C is not substantially influenced by the slot 43. See FIG. 4a and 4b in this regard.

For the purpose of implementing one of the switching states of the valve 4, the valve body 28 and the two levels 30, 38 of the valve 4, which is designed as a central switching valve, are moved by a common shaft, namely rotated about the rotational axis in a manner known per se to the person skilled in the art. The valve 4 has the seven ports A to G with the following assignment: A as return from the traction battery 8; B as feed to the chiller 22; C as feed to the front radiator 12; D as return from the drive train, namely the power electronics 16 with the electric motor 18; E as feed to the drive train; F as return from the front radiator 12; G as return from the chiller 22 and as feed to the traction battery 8. See FIGS. 1a and 1b, 2a and 2b, 3a and 3b, as well as 4a and 4b, in combination.

On account of the design according to the invention of the valve 4 for the fluid system 2 of the vehicle, the valve 4 is substantially simplified in terms of design, manufacturing, and switching in comparison with the prior art. At the same time, the functionality of the valve 4 is comparable to the functionality of far more complex valves or the use of a multiplicity of simpler valves in the prior art. By means of the valve 4, it is possible, in particular, to specify a valve that is more complex and has more possible switching states as compared to the prior art, despite the valve seal 41 designed as a slotted seal and with comparable available installation space. This is because, in the valve 4, unlike in the valves known from the prior art, the slot 43 of the valve seal 41 is in fluidic connection with at least one of the valve housing openings A to G in at least one switching state of the valve 4. In a preferred manner, the slot 43 of the valve seal 41 is in fluidic connection with at least two of the valve housing openings A to G in at least one switching state of the valve 4, wherein these valve housing openings are fluidically connected to one another in a desired manner in this switching state. See, e.g., FIG. 4b in this regard. In contrast thereto, the slot in comparable valve seals from the prior art is always arranged such that the slot is not in fluidic connection with at least one of the valve housing openings in any conceivable switching state of the known valve. The available installation space in the valves known from the prior art thus is not as extensively usable for switching states of these valves as is the case with the invention according to the present example. Accordingly, these known valves have a smaller number of possible switching states in comparison with the valve 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A valve for a fluid system of a vehicle, the valve comprising:
a valve housing having a base, a top, and a plurality of valve housing openings arranged in a side wall of the valve housing;
a valve body arranged in the valve housing so as to be rotatable about a rotational axis and having, arranged substantially perpendicular to the rotational axis, a first level that has at least one first connecting passage, and having, arranged substantially perpendicular to the rotational axis, a second level that is fluidically separated from the first level by an intermediate base and has at least one second connecting passage for fluidically connecting at least two valve housing openings of the plurality of valve housing openings; and
a valve seal that is arranged between the valve housing and the valve body and has valve seal openings corresponding to the valve housing openings; and
a valve actuator to automatically rotate the valve body about the rotational axis for setting a plurality of switching states of the valve,
wherein the valve seal is designed as a slotted seal with a continuous slot that extends along the rotational axis,
wherein the slot is in fluidic connection with at least one of the valve housing openings in at least one switching state of the valve, and
wherein the valve body and the valve seal are designed to be matched to one another such that it is ensured in every switching state of the valve that the valve housing openings are fluidically connected to one another only in the desired manner.

2. The valve according to claim 1, wherein the valve seal is designed as a slotted tube, and/or in that the valve body and the intermediate base are designed to be matched to one another such that one of the at least one first connecting passages and one of the at least one second connecting passages form a fluidic connection between the first level and the second level as a common connecting passage.

3. The valve according to claim 1, wherein the valve body and the valve seal are designed to be matched to one another such that one of the first valve housing openings and one of the second valve housing openings are fluidically connected to one another in a desired manner by the slot in at least one of the switching states of the valve, or wherein the fluidic connection is formed by one of the at least one first connecting passages and one of the at least one second connecting passages, or wherein the fluidic connection is formed solely by just one of the at least one first connecting passages and just one of the at least one second connecting passages.

4. The valve according to claim 1, wherein the valve body and the valve seal are designed to be matched to one another such that the valve body isolates the slot in terms of flow in a desired manner from every first valve housing opening and/or from every second valve housing opening in at least one of the switching states of the valve.

5. The valve according to claim 1, wherein one of the at least one first and/or at least one second connecting passages is designed such that at least three valve housing openings associated with the same level as this connecting passage is fluidically connected to one another by this connecting passage as a function of one of the switching states of the valve.

6. The valve according to claim 5, wherein three valve housing openings in total are associated with the level, or wherein these three valve housing openings are associated only with the level.

7. The valve according to claim 5, wherein the connecting passage is delimited by at least one valve body wall, or wherein the at least one valve body wall is designed as three valve housing walls.

8. The valve according to claim 7, wherein the connecting passage is fluidically separated from at least one other connecting passage of the level by at least one of the at least one valve body walls, or wherein the valve body and the intermediate base are designed to be matched to one another such that the connecting passage and/or the other connecting passage forms a fluidic connection between the first level and the second level.

9. The valve according to claim 1, wherein, at least four valve housing openings and at least three first connecting passages are associated with the first level, wherein at least three valve housing openings and at least two connecting passages are associated with the second level, or wherein at least three of the first connecting passages are fluidically separated from one another only by a single valve body wall, and/or at least two of the second connecting passages are separated only by a single valve body wall, or wherein the valve body and the intermediate base are designed to be matched to one another such that one of the first connecting passages and one of the second connecting passages are designed as a single, common connecting passage.

10. The valve according to claim 1, wherein at least four switching states are implemented by the valve, wherein the following valve housing openings are fluidically connected to one another in a first switching state: a valve housing opening A associated with the first level to a valve housing opening B associated with the first level, a valve housing opening C associated with the first level to a valve housing opening D associated with the first level, a valve housing opening E associated with the second level to the valve housing openings F and G likewise associated with the second level, and/or wherein the following valve housing openings are fluidically connected to one another in a second switching state: a valve housing opening B associated with the first level to a valve housing opening D likewise associated with the first level, a valve housing opening E associated with the second level to a valve housing opening G likewise associated with the second level, and/or wherein the following valve housing openings are fluidically connected to one another in a third switching state: a valve housing opening B associated with the first level to a valve housing opening D likewise associated with the first level, a valve housing opening C associated with the first level to a valve housing opening G associated with the second level, a valve housing opening E associated with the second level to a valve housing opening F likewise associated with the second level, and/or wherein the following valve housing openings are fluidically connected to one another in a fourth switching state: a valve housing opening A associated with the first level to a valve housing opening E associated with the second level, a valve housing opening C associated with the first level to a valve housing opening D likewise associated with the first level, a valve housing opening F associated with the second level to a valve housing opening G likewise associated with the second level.
